(19) United States
(12) Patent Application Publication
(10) Pub. No.: US 2008/0198579 A1
(43) Pub. Date: Aug. 21, 2008

(54) Hat Light

(75) Inventors: Caleb Clark Crye, Brooklyn, NY (US); Eric Owen Fehlberg, Jackson Heights, NY (US); Gregg M. Thompson, Brooklyn, NY (US)

Correspondence Address: STIENNON & STIENNON, 612 W. MAIN ST., SUITE 201, P.O. BOX 1667, MADISON, WI, 53701-1667, US

(73) Assignee: LINEWEIGHT LLC, Brooklyn, NY (US)

(21) Appl. No.: 11/565,416

(22) Filed: Nov. 30, 2006

Related U.S. Application Data
(60) Provisional application No. 60/778,553, filed on Mar. 2, 2006.

(51) Int. Cl. F21V 21/08; A42B 1/24; A42B 1/00

(52) U.S. Cl. 362/106; 2/209.13; 2/175.1; 2/195.1

(57) ABSTRACT

A hat has a first part of a hook and loop fastener defining a large patch along the underside of its brim. One or more flashlights have stiff plastic housings, each of which has a patch of a second part of the hook and loop fastener. The hook and loop fastener patches allow the flashlights to be positionably connected to the underside of the brim, providing adjustable illumination for the wearer of the hat.

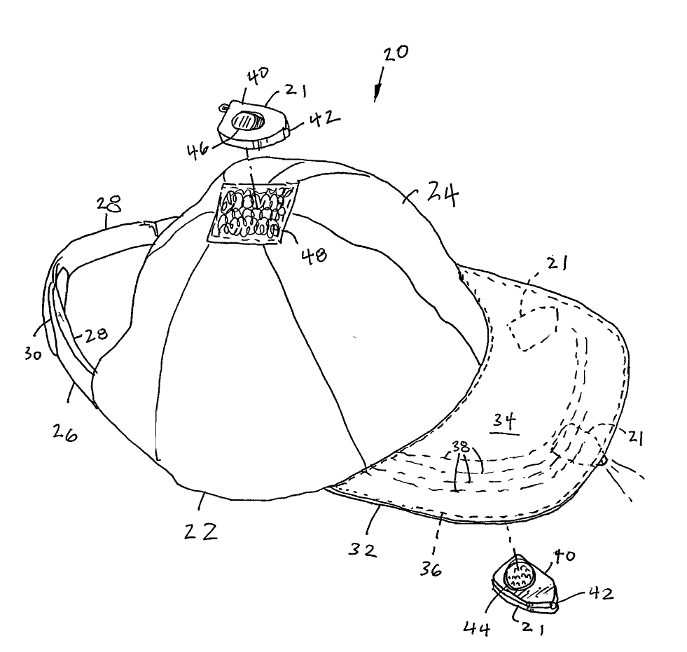

### CROSS REFERENCES TO RELATED APPLICATIONS

This application claims the benefit of U.S. provisional app. No. 60/778,553, filed Mar. 2, 2006, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to lighting systems generally, and more particularly to those which involve attachment of lights to users.

Head mounted light sources make it possible for users to have improved visibility in darkened ambient conditions while still keeping both hands free, especially facilitating work in dark places. Light emitting diode (LED) light sources have been employed as an integral part of a cap brim to direct light in the direction that a user is looking.

However, what is needed is a low cost assembly which makes it possible for a user to readily direct light in one or more directions.

### SUMMARY OF THE INVENTION

A hat has a first part of a hook and loop fastener defining a large patch along the entire underside of the cap brim. One or more flashlights have stiff plastic housings, each of which has a patch of a second part of the hook and loop fastener. The hook and loop fastener patches allow the flashlights to be positionably connected to the underside of the hat brim, providing adjustable illumination for the wearer of the hat.

It is an object of the present invention to provide a wearable lighting assembly which allows the convenient repositioning of light sources on a portion of the user's clothing.

Further objects, features and advantages of the invention will be apparent from the following detailed description when taken in conjunction with the accompanying drawings.

### BRIEF DESCRIPTION OF THE DRAWINGS

The FIGURE is an exploded top perspective view of the hat light assembly of this invention.

### DESCRIPTION OF THE PREFERRED EMBODIMENTS

Referring more particularly to the FIGURE, the hat light assembly 20 has a hat, which may be a cap 22 similar in general configuration to a conventional baseball cap to which one or more flashlights 21 are removably attached. The cap 22 has a flexible fabric crown 24 which may be comprised of several stitched together fabric segments. The cap 22 has a connecting element 26 which may be composed of two flexible strips 28 which extend at the base of the crown and which are configured to encircle the head of a wearer for attachment of the cap to the wearer. The flexible strips 28 are preferably adjustably fastened to one another to allow the cap to be adjusted in size to suit a variety of sized wearers. The flexible strips 28 may be joined by a fastener 30 such as portions of a hook and loop fastener such as VELCRO® fastener material supplied by Velcro Industries B.V.

A stiff brim 32 protrudes frontwardly from the base of the crown 24. The brim 32 may be fabricated with a stiff main panel, which may be formed into a downwardly open concave shape, with a fabric or other material top section 34 on the upwardly facing surface of the brim, and a downwardly facing bottom section 36 on the downwardly facing surface of the brim. The bottom section 36 preferably comprises one part of a hook and loop fastener, as discussed below. By making the bottom section 36 entirely of the fastener material, wrinkles can be prevented in forming where a smaller section is attached to a larger. The brim 32 may be provided with several rows of peripheral stitching 38 which extend through the top section 34, the main panel, and the bottom section 36.

Each flashlight 21 has a housing 40, formed for example of stiff plastic, which encloses a power supply such as a battery, and a light source 42, such as an LED. The light source 42 may produce visible light, or it may produce other wavelengths of light only detectable with special equipment, for example infrared light which may be detected with night vision apparatus. A patch 44 of hook and loop fastener material is connected to one side of the flashlight housing 40, while the other side of the housing 40 may be provided with a switch 46 for turning on the flashlight 21. The switch is preferably of the type which toggles the flashlight between on and off, so that it is not necessary to continue to hold down the switch to keep the flashlight activated. Together the patch 46 of material on the flashlight 21 and the bottom section 36 define both parts of a hook and loop fastener. Preferably, the brim bottom section 36 is loop material, while the flashlight patch 46 is hook material. The surface area of the brim bottom section 36 is much larger than the surface area of the patch 46, such that the flashlight 21 is removably positionable on the underside of the cap brim 32 in a wide variety of positions, allowing a user to direct light to just the region of interest. Moreover, the flashlight can readily and immediately be detached from the brim and be repositioned as desired. The patch 46 on the flashlight 21 may, for example, be a circle ¾ inch in diameter, for a surface area of about 0.4 square inches, while the brim may be about 6½ inches across, and project 2¾ inches from the crown, having a total surface area of about fifty times the surface area of the flashlight patch.

Multiple flashlights 21 can also be attached to the brim in a variety of positions, either to simultaneously light multiple regions, to be readily available to direct light in different directions, or to serve as a backup in the event that the power supply of one flashlight is depleted. The brim bottom section 36 is preferably formed of dark material to limit the reflection of light from the flashlight back to the wearer's eyes.

The cap may be provided with a top patch 48 of loop material positioned on the crown, to allow a flashlight 21 to be attached to the crown 24 of the cap 22 as desired.

It should be noted that other types of hats may be configured according to the invention, for example a boonie hat, which has a 360 degree brim, to the underside of which is affixed the one part of the hook and loop fastener.

It is understood that the invention is not limited to the particular construction and arrangement of parts herein illustrated and described, but embraces all such modified forms thereof as come within the scope of the following claims.

We claim:

1. A hat light assembly comprising:
a hat having a frontwardly projecting brim, with an element which extends from the brim for engagement of the hat with the head of a wearer, the brim having a downwardly facing underside;
a flashlight having a housing;
a first patch of a first part of a two-part hook and loop fastener connected to the underside of the brim; and
a second patch of a second part of the two-part hook and loop fastener connected to the flashlight housing, the first patch being positionably engagable with the second patch to thereby mount the flashlight to the hat in a selected position and orientation.

2. The hat light assembly of claim 1 wherein the first patch has a greater surface area than the second patch, such that the flashlight may be releasably connected to the hat in a plurality of positions.

3. The hat assembly of claim 1 further comprising a third patch of hook and loop fastener material fastened to a crown of the hat positioned upwardly of the brim, wherein the flashlight may alternatively be connected to the hat crown or the hat brim.
